(19) United States
(12) Patent Application Publication
(10) Pub. No.: US 2020/0041795 A1
(43) Pub. Date: Feb. 6, 2020

(54) VIRTUAL IMAGE DISPLAY DEVICE AND ENLARGEMENT OPTICAL SYSTEM

(71) Applicant: SEIKO EPSON CORPORATION, Tokyo (JP)

(72) Inventors: Tokito YAMAGUCHI, Azumino-shi (JP); Masayuki TAKAGI, Azumino-shi (JP); Toshiaki MIYAO, Matsumoto-shi (JP); Akira KOMATSU, Kmiina-gun (JP); Takashi TAKEDA, Suwa-shi (JP)

(73) Assignee: SEIKO EPSON CORPORATION, Tokyo (JP)

(21) Appl. No.: 16/531,545

(22) Filed: Aug. 5, 2019

(30) Foreign Application Priority Data
Aug. 6, 2018 (JP) 2018-147433

(51) Int. Cl. G02B 27/01; G02B 3/08

(52) U.S. Cl. CPC G02B 27/0172; G02B 2027/0178; G02B 3/08

(57) ABSTRACT

A virtual image display device includes an image element configured to display an image, a first optical unit disposed at a position where image light is extracted, a second optical unit disposed at the image element side with respect to the first optical unit, a half mirror provided on a serrated surface formed at a bonding portion between the first optical unit and the second optical unit, and a transmission/reflection selection member that is provided at a light emitting side of the first optical unit and that is configured to selectively transmit or reflect light depending on a polarization state of the light.

The present application is based on, and claims priority from JP Application Serial Number 2018-147433, filed Aug. 6, 2018, the disclosure of which is hereby incorporated by reference herein in its entirety.

### BACKGROUND

### 1. Technical Field

The present disclosure relates to a virtual image display device and an enlargement optical system.

### 2. Related Art

As an eyepiece optical system applicable to a head-mounted display and the like, for example, as described in JP-A-2001-356295, an eyepiece optical system is known in which a lens surface close to a pupil and a lens surface close to a panel are aspheric surfaces to reduce occurrence of a field curvature. Note that the head-mounted display is also described as an HMD in the following.

However, in the case of the configuration as in JP-A-2001-356295, for example, a field curvature occurring in the most powerful concave mirror may not be suppressed, for example.

### SUMMARY

A virtual image display device according to an aspect of the present disclosure includes an image element configured to display an image, a first optical unit disposed at a position where image light is extracted, a second optical unit disposed at the image element side with respect to the first optical unit, a half mirror provided on a serrated surface formed at a bonding portion between the first optical unit and the second optical unit, and a transmission/reflection selection member that is provided at a light emitting side of the first optical unit and that is configured to selectively transmit or reflect light depending on a polarization state of the light.

### BRIEF DESCRIPTION OF THE DRAWINGS

FIG. 1 is a side cross-sectional view for conceptually describing a configuration example of an enlargement optical system and a virtual image display device according to First Exemplary Embodiment.

FIG. 2 is an exploded view for describing a configuration of the virtual image display apparatus.

FIG. 3 is a partially enlarged view for describing a structure of the enlargement optical system of the virtual image display device.

FIG. 4 is a conceptual view for describing a manufacturing step of the enlargement optical system in a modified example.

FIG. 5 is a conceptual view for describing a flow of an adhesive during manufacturing of the enlargement optical system.

FIG. 6 is a side cross-sectional view and a partially enlarged view for conceptually describing a configuration example of a virtual image display device according to Second Exemplary Embodiment.

FIG. 7 is a partially enlarged view of an enlargement optical system for describing a virtual image display device in a comparative example.

FIG. 8 is a side cross-sectional view and a partially enlarged view for conceptually describing a configuration example of a virtual image display device according to Third Exemplary Embodiment.

FIG. 9 is a side cross-sectional view for conceptually describing the virtual image display device in a modified example.

FIG. 10 is a side cross-sectional view for conceptually describing the virtual image display device in another modified example.

FIG. 11 is a conceptual view of an appearance and a configuration for describing the virtual image display device in still another modified example.

FIG. 12 is a plane cross-sectional view for conceptually describing a configuration example of the virtual image display device in FIG. 11.

### DESCRIPTION OF EXEMPLARY EMBODIMENTS

### First Exemplary Embodiment

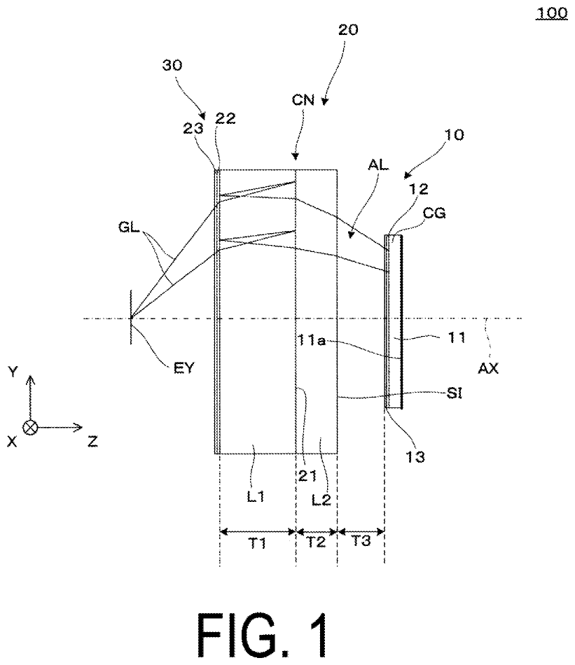

An enlargement optical system and a virtual image display device including the enlargement optical system according to First Exemplary Embodiment of the present disclosure will be described below in detail with reference to FIG. 1 and the like.

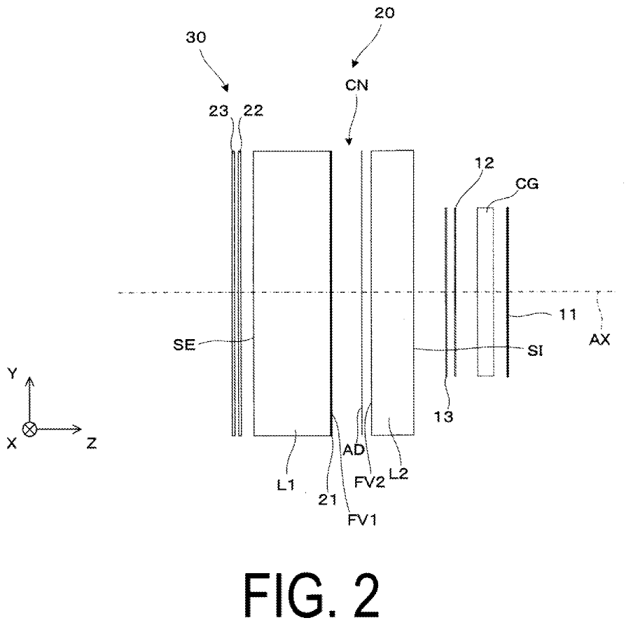

As conceptually illustrated in FIG. 1 and FIG. 2 in which a configuration example in FIG. 1 is disassembled, a virtual image display device 100 of the exemplary embodiment includes an image display device 10 being an image element (image display unit) and an enlargement optical system 20, and serves as a virtual image display device, that is, a head-mounted display (HMD) capable of causing an observer or a user wearing the virtual image display device 100 to visually recognize image light (image light) by a virtual image. Here, FIG. 1 conceptually illustrates a state of a cross section as viewed from a side when an observer wears the virtual image display device 100. It is assumed in FIG. 1 and the like that an optical axis AX of the optical system in the virtual image display device 100 is a Z direction. Further, among in-plane directions of a surface orthogonal to the Z direction, a horizontal direction, that is, a right-left direction is an X direction, and among the in-plane directions, a direction orthogonal to the X direction is a Y direction. In this case, a horizontal direction assumed to be a direction in which the right and left eyes of an observer are aligned is the X direction. Then, an up-down direction for an observer which is a direction orthogonal to the horizontal direction is a vertical direction, and is the Y direction in FIG. 1 and the like. Additionally, a position of an eye EY of an observer, in a configuration of the virtual image display device 100, is a position of a pupil assumed as a location in which the eye EY of the observer is located.

Note that the image display device 10 and the enlargement optical system 20 are prepared for each of the right eye and the left eye and are each in a right-left pair configuration, but here, since a configuration of a left side and a configuration of a right side are symmetric, only one side (for the left eye) of the right and left sides is illustrated, and the other side is omitted. For example, in FIG. 1, an ear is located in the +X direction with respect to the eye EY of the observer, and a nose is located in the −X direction with respect to the eye EY of the observer. Note that the virtual image display device 100, as only one of the right-left pair, namely, independently functions as the virtual image display device. Additionally, the virtual image display device can also be configured for a single eye without the right-left pair configuration.

An example of a structure and the like of each of units for guiding image light by the virtual image display device 100 will be described conceptually below.

First, the image display device 10 includes a panel unit 11 being a main body portion to form an image and configured to emit image light GL, a cover glass CG covering a light emitting surface 11a of the panel unit 11, a polarizing plate 12, and an incident side polarization conversion member 13. Here, a small image display device is adopted as the image display device 10, and as in the figure, the image display device 10 is configured, at least, to be smaller than the enlargement optical system 20, with respect to a direction orthogonal to the optical axis AX. Specifically, for example, in the example illustrated, it is obvious that a size of an image display area of the image display device 10 is smaller than a size of an optical surface of a second lens L2 of the enlargement optical system 20 described below.

The panel unit 11 being a display device can be an image element (image display element) including a self-light-emitting type element (OLED) such as an organic electro-luminescence (EL), for example. The panel unit 11 may be, for example, a self-light-emitting type display element represented by an inorganic EL, an LED array, an organic LED, a laser array, a quantum dot light emitting element, and the like in addition to the organic EL. The panel unit 11 forms a colored still image or a moving image in the two-dimensional light emitting surface 11a. The panel unit 11 is driven by a drive control circuit (not illustrated) to perform a display operation. When an organic EL display is used as the panel unit 11, the panel unit 11 includes an organic EL control unit. When a quantum dot display is used as the panel unit 11, light of a blue light emitting diode (LED) passes through a quantum dot film to produce a green or red color. The panel unit 11 is not limited to the self-light-emitting type display element, and may include an LCD or another light modulating element, and may form an image by illuminating the light modulating element with a light source such as a backlight. As the panel unit 11, a liquid crystal on silicon (LCoS is a trade name), a digital micromirror device, and the like may be used instead of the LCD.

Here, from a viewpoint of definition enhancement or the like, as an image element used for the panel unit 11 of the image display device 10, for example, a case where a small image element such as a micro display is desirably adopted is conceivable. Since there is a proportional relationship between a panel size and a panel unit price for, for example, a liquid crystal panel using an HTPS or Si backplane, or an OLED panel, these panels need to be applied to realize definition enhancement. That is, from a practical viewpoint of reducing a product cost or the like, a smaller panel needs to be applied. However, when miniaturing a panel is attempted, and at the same time an angle of view is widened, that is, when applying a smaller panel size is attempted, a focal distance of an optical system also needs to be reduced. That is, a curvature radius of a lens needs to be reduced. In this case, in a component of light in a wide visual field angle side, due to a restriction of a total reflection condition in a lens surface, a shape having strong curvature cannot be adopted, and desirable reduction in a panel size may not be achieved. In the virtual image display device 100 of the exemplary embodiment, in view of the above, miniaturization of the panel unit 11 is realized.

The polarizing plate 12 is adhered on a light emitting surface of the cover glass CG. The polarizing plate 12 is a transmissive polarizing plate, and is a member for extracting a linearly polarized light component of the image light GL when the image light GL from the panel unit 11 passes through the member.

The incident side polarization conversion member 13 is adhered on a light emitting surface of the polarizing plate 12. The incident side polarization conversion member 13 is a quarter wavelength plate, that is, a λ/4 plate, and converts a polarization state of light passing through. That is, the incident side polarization conversion member 13 is located downstream of an optical path of the polarizing plate 12, and converts the image light GL passing through the polarizing plate 12 from the linearly polarized light to circularly polarized light. Additionally, as illustrated, the incident side polarization conversion member 13 is a member located furthest downstream of an optical path of the image display device 10, that is, located near the enlargement optical system 20.

Here, a gap is appropriately provided between the image display device 10 and the enlargement optical system 20 by an air layer AL.

Next, the enlargement optical system 20 includes, in addition to two lenses, first and second lenses L1 and L2 being a first optical unit and a second optical unit bonded and arranged in order from an observer side, a half mirror 21 at a bonding location between a first lens L1 and the second lens L2, and a transmission/reflection selection member 30 at the light emitting side. Further, the transmission/reflection selection member 30 includes an emitting side polarization conversion member 22, and a semi-transmissive reflection type polarizing plate 23. Note that the first and second lenses L1 and L2 are conceivably resin lenses, but the first and second lenses L1 and L2 may be glass lenses as long as the first and second lenses L1 and L2 can be manufactured.

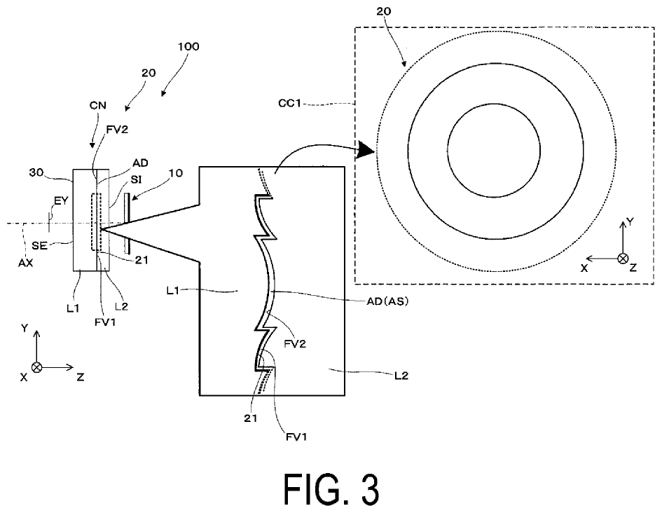

First, the first lens L1 being the first optical unit is disposed at an extracting position for extracting the image light GL to the outside of the device in a front-of-eye side of the observer, that is, in a −Z side close to the eye EY of the lenses constituting the enlargement optical system 20, and includes a light emitting plane SE being a flat surface as a light emitting surface in the front-of-eye side. On the other hand, as illustrated in a partially enlarged view in FIG. 3, the first lens L1 is a Fresnel lens formed concentrically engraved by a Fresnel surface FV1 including a serrated surface in the image display device 10 side being an opposite side to the light emitting plane SE. That is, as a state of a partially enlarged location surrounded by a dashed line CC1 illustrated in FIG. 3, the enlargement optical system 20 is obtained by dividing a regular lens into concentric circular regions as viewed from the front surface or the back surface. As a result, the enlargement optical system 20 is a lens having a thickness further reduced than a thickness of a regular lens, and further includes a serrated cross section. Note that the first lens L1 is a highly refractive lens with a refractive index of, for example, 1.8 or greater, to obtain an image having a sufficiently wide angle of view. Additionally, the Fresnel surface FV1 is a spherical surface. That is, the first lens L1 is a spherical surface planoconvex lens.

Next, the second lens L2 being the second optical unit is disposed closer to the image display device 10 side than the first lens L1, and includes a light incident plane SI being a flat surface as a light incident surface in which the image light GL from the image display device 10 is incident on the image display device 10 side. On the other hand, as illustrated in the partially enlarged view in FIG. 3, the second lens L2 is a Fresnel lens including a Fresnel surface FV2 including a serrated surface in the front-of-eye side being an opposite side to the light incident plane SI. A concave-convex shape of the Fresnel surface FV2 of the second lens L2 corresponds to a concave-convex shape of the Fresnel surface FV1 of the first lens L1. Note that, in the case above, in the figure, the serrated surface is illustrated by a cross section of a YZ surface being one of surfaces along the direction of the optical axis AX, but the Fresnel surfaces FV1 and FV2 each also have a similar shape in the other cross section along the direction of the optical axis AX.

The first lens L1 and the second lens L2 are bonded in the Fresnel surface FV1 and the Fresnel surface FV2, and form a bonding portion CN.

Note that a refractive index of the second lens L2 is equal to a refractive index of the first lens L1, or is smaller than the refractive index of the first lens L1. Additionally, the second lens L2 is thicker than the first lens L1 in the direction of the optical axis AX. That is, thicknesses T1 and T2 in the direction of the optical axis AX of the first and second lenses L1 and L2 in the figure are T1<T2.

Additionally, both the light emitting plane SE and the light incident plane SI are parallel to the light emitting surface 11a of the image display device 10, and in the example illustrated, are parallel to an XY plane. Note that, as a tolerance of parallelism here, for example, within ±2° is conceivable. Of these planes SE and SI, the light incident plane SI, in particular, is located upstream of an optical path of the second lens L2, that is, at a position closest to the image display device 10 of the enlargement optical system 20.

The half mirror 21 is a semi-reflective and semi-transmissive film for transmitting a portion of image light and reflecting another portion of the image light, and includes a dielectric multilayer film, a metal film, and the like, for example. As illustrated, the half mirror 21 is formed between the first lens L1 and the second lens L2. That is, the half mirror 21 is provided in the bonding portion CN. Further, in this case, the half mirror 21 includes a serrated surface. In other words, the half mirror 21 includes, as an optical surface, a surface having a shape corresponding to a shape of a serrated surface formed in the bonding portion CN in the first and second lenses L1 and L2. Additionally, it can also be said from a different perspective that the second lens L2 is a counter member with respect to the first lens L1 being a Fresnel lens and sandwiches the half mirror 21 in the bonding portion CN with the first lens L1.

Here, an example of forming the half mirror 21 or the bonding portion CN will be described. As an example of a configuration of the enlargement optical system 20 illustrated in an exploded view in FIG. 2, firstly, a film to be the half mirror 21 is formed on the Fresnel surface FV1 of the first lens L1 by vapor deposition. Next, the formed film of the half mirror 21 and the Fresnel surface FV2 of the second lens L2 are bonded by an adhesive, and this adhesive cures to form an adhesive film AD. Thus, the bonding portion CN is formed. Note that, although details will be described below, the adhesive film AD is not provided in a first lens L1 side, but in a second lens L2 side, thus the number of passages through the adhesive film AD can be reduced when the image light GL passes through the enlargement optical system 20.

As described above, the transmission/reflection selection member 30 includes the emitting side polarization conversion member 22, and the semi-transmissive reflection type polarizing plate 23, and selectively performs transmission or reflection according to a polarization state of light.

The emitting side polarization conversion member 22 of the transmission/reflection selection member 30 is a quarter wavelength plate, that is, a λ/4 plate, and converts a polarization state of light passing through. As illustrated, the emitting side polarization conversion member 22 is adhered in the light emitting plane SE of the first lens L1, and is provided between the first lens L1 and the semi-transmissive reflection type polarizing plate 23. The emitting side polarization conversion member 22 converts a polarization state of a component traveling back and forth between the semi-transmissive reflection type polarizing plate 23 and the half mirror 21. Here, the emitting side polarization conversion member 22 being the quarter wavelength plate converts the image light GL being in a state of circular polarization of light to the linearly polarized light, or, conversely, converts the image light GL being in a state of linear polarization of light to the circularly polarized light.

The semi-transmissive reflection type polarizing plate 23 of the transmission/reflection selection member 30 is adhered in the light emitting plane SE via the emitting side polarization conversion member 22. That is, the semi-transmissive reflection type polarizing plate 23 is a member disposed in a side closest to a position of a pupil assumed as a position of the eye EY of the observer, and emits the image light GL toward the front-of-eye side of the observer. Here, the semi-transmissive reflection type polarizing plate 23 includes a reflective type wire grid polarizing plate. That is, the semi-transmissive reflection type polarizing plate 23 changes a transmission/reflection characteristic depending on whether a state of polarization of an incident component is in a polarization transmission axis direction. In this case, since the emitting side polarization conversion member 22 is disposed upstream of an optical path of the semi-transmissive reflection type polarizing plate 23, a polarization state of light changes each time the light passes through the emitting side polarization conversion member 22, and the semi-transmissive reflection type polarizing plate 23 transmits or reflects the incident component according to the change. Here, as an example, a horizontal direction (X direction) assumed as a direction in which the eyes of the observer are arranged is the polarization transmission axis direction. Note that the semi-transmissive reflection type polarizing plate 23 including the reflection type wire grid polarizing plate changes the transmission/reflection characteristic according to a state of polarization of the incident component, thus may also be referred to as a reflection type polarizing plate.

The transmission/reflection selection member 30 includes the emitting side polarization conversion member 22, and the semi-transmissive reflection type polarizing plate 23 as described above, thus can change a polarization state of light and according to the change, selectively transmits or reflects the light.

As described above, in the exemplary embodiment, the enlargement optical system 20 includes two optical units (lenses) being main portions of an optical system, and these lenses are bonded not to provide an air space, and lens-shaped surfaces provided between these optical units are the Fresnel surfaces FV1 and FV2, and the half mirror 21 is provided in this location. Further, the light incident plane SI being a surface of the lens, and the light emitting plane SE are flat surfaces. As described above, shortening along an optical axis direction, and miniaturization or thinning can be achieved. Further, in the exemplary embodiment, the half mirror 21 includes a serrated surface having a Fresnel shape, thus occurrence of a field curvature is suppressed. In particular, in this case, an effect in occurrence of a field curvature in the image peripheral side is particularly expected by appropriately adjusting the shapes of the Fresnel surfaces FV1 and FV2 or the half mirror 21.

Additionally, in the case of the exemplary embodiment, since each of the light incident plane SI and the light emitting plane SE is a flat surface, a polarizing plate, a quarter wavelength plate, a reflection type wire grid polarizing plate, and the like can be adhered directly and easily in these planes as various optical sheets as described above, and reduction of the number of components, miniaturization of an optical component, and performance improvement can be achieved.

An optical path of the image light GL will be described below briefly with reference to FIG. 1. First, the image light GL modulated in the panel unit 11 in the image display device 10 is converted to linearly polarized light in the polarizing plate 12 being a transmissive polarizing plate. Here, a polarization direction of the linearly polarized light having passed through the polarizing plate 12 is a first direction. After the image light GL is converted to linearly polarized light in a first direction by the polarizing plate 12, the image light GL is converted to circularly polarized light by the incident side polarization conversion member 13 being a first quarter wavelength plate, and is emitted toward the enlargement optical system 20 through the air layer AL.

The image light GL emitted is incident on the second lens L2 from the light incident plane SI located closest to the image display device 10 side of the enlargement optical system 20. Subsequently, the image light GL reaches an interface between the second lens L2 and the first lens L1, that is, the half mirror 21 provided in the bonding portion CN. Some components of the image light GL pass through the half mirror 21, and are converted to linearly polarized light by the emitting side polarization conversion member 22 being a second quarter wavelength plate. Here, after the linearly polarized light passes through the polarizing plate 12, the linearly polarized light passes through the quarter wavelength plate twice, thus the polarization direction of the linearly polarized light is a different direction by 90° with respect to the first direction. Here, this direction is referred to as a second direction. After the image light GL is converted to the linearly polarized light in the second direction by the emitting side polarization conversion member 22, the image light GL reaches the semi-transmissive reflection type polarizing plate 23 or a reflection type polarizing plate.

Here, the semi-transmissive reflection type polarizing plate 23 is set to transmit linearly polarized light in the first direction, and to reflect linearly polarized light in the second direction. From another perspective, a transmission characteristic of the polarizing plate 12 or a transmission/reflection selection characteristic of the semi-transmissive reflection type polarizing plate 23 is configured as such. In this case, the image light GL being the linearly polarized light in the second direction is reflected by the semi-transmissive reflection type polarizing plate 23, and again becomes circularly polarized light in the emitting side polarization conversion member 22 being a quarter wavelength plate, and reaches the half mirror 21. At the half mirror 21, some components of the image light GL pass through as they are, but the remaining components are reflected, and the components of the image light GL reflected are this time converted to the linearly polarized light in the first direction by the emitting side polarization conversion member 22 being a quarter wavelength plate. The components of the image light GL converted to the linearly polarized light in the first direction pass through the semi-transmissive reflection type polarizing plate 23, and the image light GL reaches a position of a pupil assumed as a location in which the eye EY of an observer exists.

Note that, as described above, the half mirror 21 is vapor-deposited in the first lens L1 side, and is subsequently adhered and fixed in the second lens L2 via the adhesive film AD. Accordingly, in the above-described optical path, after the image light GL is reflected by the semi-transmissive reflection type polarizing plate 23, the image light GL does not pass through the adhesive film AD, but is reflected by the half mirror 21. That is, the image light GL passes through the adhesive film AD only once when the image light GL passes through between the first lens L1 and the second lens L2 for the first time. As described above, the number of passages through the adhesive film AD is reduced as far as possible, and thus reduction in a component amount of the image light GL and deterioration of the image light GL are suppressed.

As described above, in the enlargement optical system 20 in the virtual image display device 100 of the exemplary embodiment, the half mirror 21 and the transmission/reflection selection member 30 can fold the optical path of the image light GL, and the image light GL can have a wide angle of view by utilizing the reflection at the half mirror 21 provided in a curved surface, and the like.

Note that, in the case above, the two lenses L1 and L2 in the enlargement optical system 20 include the light incident plane SI and the light emitting plane SE that are flat surfaces. Thus, a location of curved surface portions in which the two lenses L1 and L2 are bonded, is in charge of optical path adjustment for each pencil of rays constituting the image light GL. That is, a reflection action at the half mirror 21 formed in this surface, and a refraction action due to a refractive index difference or the like between the two lenses L1 and L2 adjust the optical path. The enlargement optical system 20 having the configuration as described above can be formed by using glass materials having different refractive indexes and different Abbe numbers for the two lenses L1 and L2.

Additionally, in the exemplary embodiment, a relationship between the thickness T2 of the second lens L2 located in the image display device 10 side of the enlargement optical system 20 and a thickness T3 of the air layer AL, that is, a distance in the direction of the optical axis AX from the image display device 10 to the enlargement optical system 20 is T2<T3. That is, a value of the thickness T3 of the air layer AL is greater. The thickness T2 and the thickness T3 are determined according to a focal distance of the entire optical system on a design, and, for example, a sum of the thickness T2 and the thickness T3 (T2+T3) is constant from demand for the focal distance. That is, the second lens L2 and the air layer AL have a relationship in which an increase in a thickness of the second lens L2 reduces a thickness of the air layer AL, that is, an air gap thickness, and a reduction in a thickness of the second lens L2 increases the air gap thickness. In the example described above, T2<T3, that is, the thickness of the second lens L2 is reduced, thus weight reduction of the enlargement optical system 20 and consequently weight reduction of the virtual image display device 100 are achieved. Additionally, a configuration that is strong to a manufacturing tolerance can be expected by increasing the air gap thickness. In this case, even when, for example, power in the optical system changes due to a manufacturing tolerance, it is conceivable that adjustment to a predetermined focus position is more easily performed by adjusting the air gap thickness. When the air gap thickness is too thin, a limit of the adjustment is easily reached, and tolerance setting may need to be strict from contact between the image display device 10 and the second lens L2 of the enlargement optical system 20. According to the configuration described above, such a situation can be avoided or reduced. Note that the thickness T1 of the first lens L1 being one of the lens of the enlargement optical system 20 is determined according to an angle of view and a panel size of the panel unit 11 in the image display device 10.

Additionally, with regard to dimensions of each unit and the like, a length of the side of the panel size of the panel unit 11 of the image display device 10, for example, is preferably equal to or less than 2.5 inches, further equal to or less than 1 inch (more preferably, about 12 to 13 mm) from a viewpoint of demand for miniaturization. In the exemplary embodiment, a small panel such as a micro display is used as the image display device 10, and an image by this panel is enlarged by the enlargement optical system 20, thus an image having a wide angle of view can be formed.

Additionally, in a virtual image display device such as an HMD, an angle of view has been widened, and an optical system has a very short focal distance. Here, as for an FOV, an aspect in which a half angle of view is 50°, that is, a full angle of view is 100° is assumed.

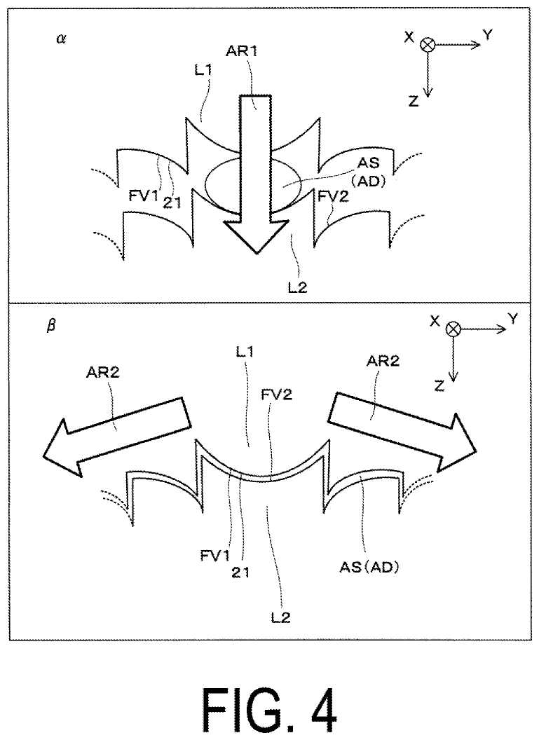

A manufacturing step of the enlargement optical system will be described below with reference to FIG. 4 and the like. FIG. 4 is a conceptual view for describing a manufacturing step of the enlargement optical system 20 in a modified example. In an example here, first, as illustrated at step a in a top section of FIG. 4, an adhesive AS to be the adhesive film AD is applied to the center side of the Fresnel surface FV2 being the surface of the second lens L2 disposed in the lower side, and the Fresnel surface FV1 being the surface of the first lens L1 and provided with the half mirror 21 is pressed from the upper side in a direction of an arrow AR1 (gravity direction), and thus the first lens L1 and the second lens L2 are bonded. Note that, for simplicity of the description, a surface provided with the half mirror 21 of the Fresnel surface FV1 is also simply described below as the first lens L1.

When the first lens L1 and the second lens L2 are bonded as described above, as illustrated at step β in a lower section of FIG. 4, it is desirable that the adhesive AS evenly extends and spreads in a direction of an arrow AR2 as the first lens L1 is pressed. Thus, in a modified example illustrated, a difference in a height is provided in the serrated surface from a center portion of the lenses L1 and L2 toward a side surface portion (peripheral portion). More specifically, for example, for each of serrated portions constituting the shape of the Fresnel surface FV2 in the second lens L2, the center portion to which the adhesive AS is first applied is the highest, and each of the serrated portions is gradually lowered as each of the serrated portions goes to the peripheral side. Additionally, the Fresnel surface FV1 in the first lens L1 side also conforms to the shape of the second lens L2. This results in an effect of filling the adhesive AS from the center portion and causing the adhesive AS to spread entirely toward the side surface (periphery) of each of the lenses L1 and L2.

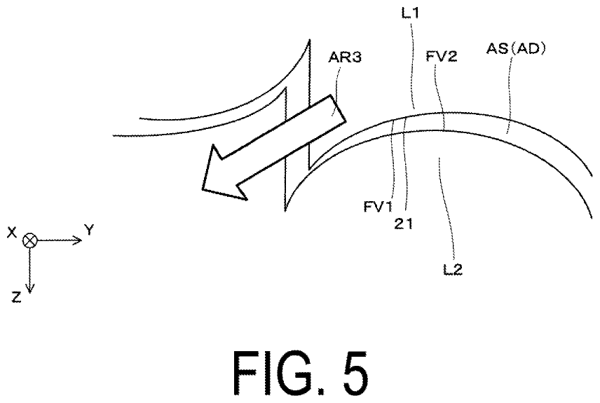

Additionally, in this case, as illustrated in FIG. 5, for example, a flow of the adhesive AS enables the first lens L1 to slide in, for example, a direction of an arrow AR3 by a dead weight between the Fresnel surface FV1 and the Fresnel surface FV2, thus the first lens L1 can be bonded easily to a position as designed. Additionally, in this case, a space between the Fresnel surfaces FV1 and FV2 is reduced, and a capillary phenomenon is accelerated. Thus, this results in an effect of causing the adhesive AS to entirely and uniformly spread. Note that a material having the same refractive index as a refractive index of the directly bonded optical unit of the first and second lenses L1 and L2 is conceivably used for the adhesive AS. That is, in this case, a material having the same refractive index as a refractive index of the second lens L2 is used as the adhesive AS.

As described above, the virtual image display device according to the exemplary embodiment includes an image element configured to display an image, a first optical unit disposed at a position where image light is extracted, a second optical unit disposed at the image element side with respect to the first optical unit, a half mirror provided on a serrated surface formed at a bonding portion between the first optical unit and the second optical unit, and a transmission/reflection selection member that is provided at a light emitting side of the first optical unit and that is configured to selectively transmit or reflect light depending on a polarization state of the light.

In the above-described virtual image display device, the first optical unit and the second optical unit are bonded, and the half mirror is provided in the bonding portion of the first optical unit and the second optical unit. Accordingly, miniaturization or thinning are realized, and at the same time, power is provided and image formation with a wide angle of view is performed. At this time, in particular, the half mirror provided at the bonding portion between the first optical unit and the second optical unit includes a serrated surface. As a result, necessary power is provided, and at the same time, further miniaturization and thinning can be achieved, and occurrence of a field curvature can also be suppressed.

### Second Exemplary Embodiment

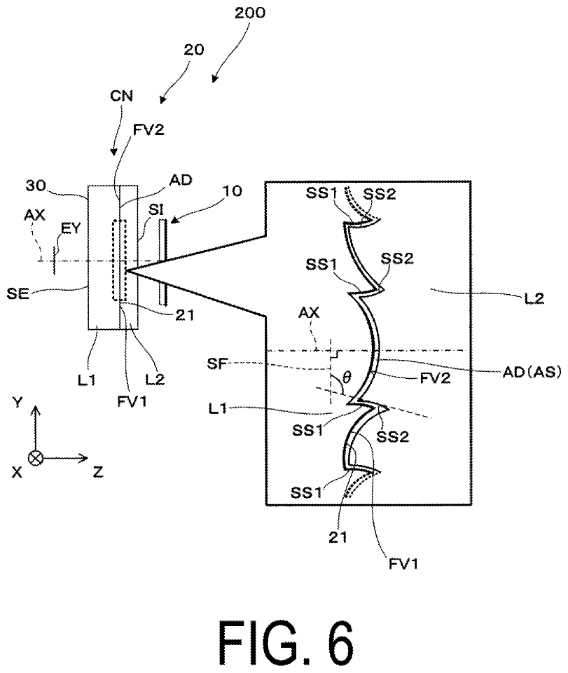

An example of a virtual image display device according to Second Exemplary Embodiment will be described with reference to FIG. 6.

The virtual image display device according to the exemplary embodiment is a modified example of the virtual image display device described in First Exemplary Embodiment, and is similar to the case in First Exemplary Embodiment except for a matter about a Fresnel shape. Thus, description throughout the virtual image display device is omitted, and only a structure related to the Fresnel shape will be described.

FIG. 6 is a side cross-sectional view and a partially enlarged view for conceptually describing a configuration example of a virtual image display device 200 according to the exemplary embodiment, and is a view corresponding to FIG. 3.

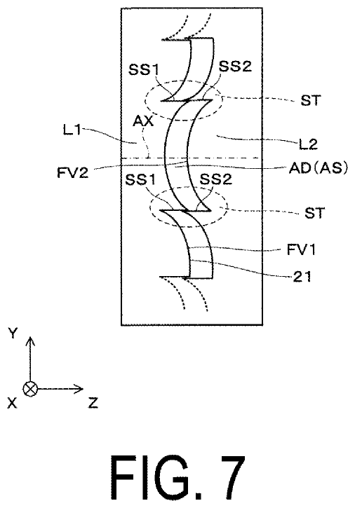

As illustrated in FIG. 6, in the virtual image display device 200 of the exemplary embodiment, a serrated surface is angled in a bonding portion CN. Namely, a surface formed by applying a Fresnel surface FV1, more precisely, the half mirror 21, and side surface portions SS1 and SS2 known as rise surfaces forming a step without having an optical function in a Fresnel surface FV2 each include a tapered surface. Here, as for a Fresnel lens, from a concern of occurrence of glare and the like, the side surface portions SS1 and SS2 being rise surfaces are generally preferably a surface that is 90° (or parallel to an optical axis AX) with respect to a reference surface of a lens, that is, a surface perpendicular to the optical axis AX, as in a comparative example illustrated in FIG. 7, for example. However, in this case, as indicated by a dashed line range ST in the comparative example of FIG. 7, the side surface portions SS1 and SS2 may get stuck in locations of the side surface portions SS1 and SS2 during bonding. In contrast, in the exemplary embodiment, the serrated surface is angled to some extent, and at the same time avoiding occurrence of glare is considered, thus such a situation is avoided. Here, for example, an angle θ of the side surface portions SS1 and SS2 with respect to a reference surface SF perpendicular to the optical axis AX illustrated in FIG. 6 is set to be in the range of 90° to 95°. Note that when the angle θ exceeds 95°, it is conceivable that a glare such as a light beam passing through the side surface portions SS1 and SS2 and appearing as a bright line of an image may occur. Additionally, as described above, when the serrated surface has an angled shape, the lenses L1 and L2 including, for example, a resin lens are easily removed from a mold during molding. Thus, this also results in an effect of reducing manufacturing difficulty as compared when a serrated surface is, for example, at a right angle.

In the virtual image display device 200 according to the exemplary embodiment, the half mirror 21 provided at the bonding portion CN of the first lens L1 and the second lens L2 includes the serrated surface. Thus, necessary power is provided, and at the same time, further thinning and miniaturization can be achieved, and occurrence of a field curvature can also be suppressed. Additionally, in the case of the exemplary embodiment, the side surface portions SS1 and SS2 each include a tapered surface, thus it is possible to avoid the locations of the side surface portions SS1 and SS2 getting stuck during bonding and to reduce, for example, manufacturing difficulty.

### Third Exemplary Embodiment

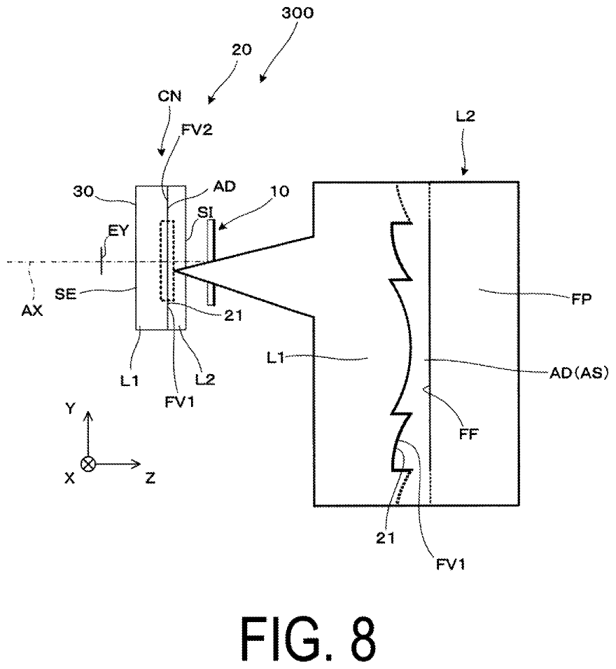

An example of a virtual image display device according to Third Exemplary Embodiment will be described with reference to FIG. 8.

The virtual image display device according to the exemplary embodiment is a modified example of the virtual image display device described in First Exemplary Embodiment and the like, and is similar to the case in First Exemplary Embodiment and the like except for a matter about a Fresnel shape. Thus, description throughout the virtual image display device is omitted, and only a structure related to the Fresnel shape will be described.

FIG. 8 is a side cross-sectional view and a partially enlarged view for conceptually describing a configuration example of a virtual image display device 300 according to the exemplary embodiment, and is a view corresponding to FIG. 3 and the like.

As illustrated in FIG. 8, in the virtual image display device 300 according to the exemplary embodiment, an enlargement optical system 20 is configured by bonding via an adhesive AS a first lens L1 being a first optical unit and including a Fresnel surface FV1 and a flat plate member FP being a second optical unit.

The enlargement optical system 20 constituting the virtual image display device 300 in the exemplary embodiment will be more specifically described below.

First, also in the exemplary embodiment, a half mirror 21 is formed in the Fresnel surface FV1 of the first lens L1. Thus, the half mirror 21 includes a serrated surface. On the other hand, in the formation of a bonding portion, one of the surfaces that is to be bonded to the Fresnel surface FV1 is a flat surface FF of the flat plate member FP instead of having a Fresnel shape. In this case, for example, a material having the same refractive index as a refractive index of the flat plate member FP being a directly bonded optical unit of the first lens L1 being the first optical unit and the flat plate member FP being the second optical unit is used for the adhesive AS to be an adhesive film AD. Thus, the adhesive film AD formed by curing the adhesive AS is integrated with the flat plate member FP as an optical function. Namely, in the above-described aspect, the refractive index of the adhesive film AD (adhesive AS) is equal to the refractive index of the flat plate member FP, thus a light beam passing through the location is not refracted due to a change in a medium between the adhesive film AD and the flat plate member FP in a design. In other words, the adhesive film AD and the flat plate member FP are integrated and function to correspond to the second lens L2 being one Fresnel lens.

Note that, as a method of manufacturing a bonding portion CN including the configuration as described above, various methods such as a method of applying the adhesive AS to the first lens L1 disposed at the lower side with the Fresnel surface FV1 facing upward and then pressing the flat plate member FB from the upper side are conceivable. As one of the specific methods, manufacturing by the following procedure is conceivable. First, the adhesive AS being UV curable is poured into a gap of the Fresnel surface FV1 of the first lens L1, and the unnecessary adhesive AS that leaks out is leveled. Next, irradiation with UV light is performed to cure the adhesive AS that fills the gap of the Fresnel surface FV1. Finally, the adhesive AS being second UV curable is applied to the bonding location between the first lens L1 and the flat plate member FP, and irradiation with UV light is performed to cure the adhesive AS being second UV curable. As a result, the adhesive film AD reliably filling the Fresnel surface FV1 without a gap can be formed.

Again in the virtual image display device 300 according to the exemplary embodiment, the half mirror 21 provided at the bonding portion CN of the first lens L1 and the flat plate member FP or the second lens L2 including the flat plate member FP includes the serrated surface. Thus, necessary power is provided, and at the same time, further thinning and miniaturization can be achieved, and occurrence of a field curvature can also be suppressed. Additionally, in the case of the exemplary embodiment, the Fresnel surface can be formed only in the first lens L1 side, that is, only in the first optical unit side, and the flat plate member FP can be provided in the other second optical unit side. Thus, manufacturing cost and manufacturing difficulty can be reduced.

Several modifications related to First Exemplary Embodiment and the like described above are described below as examples.

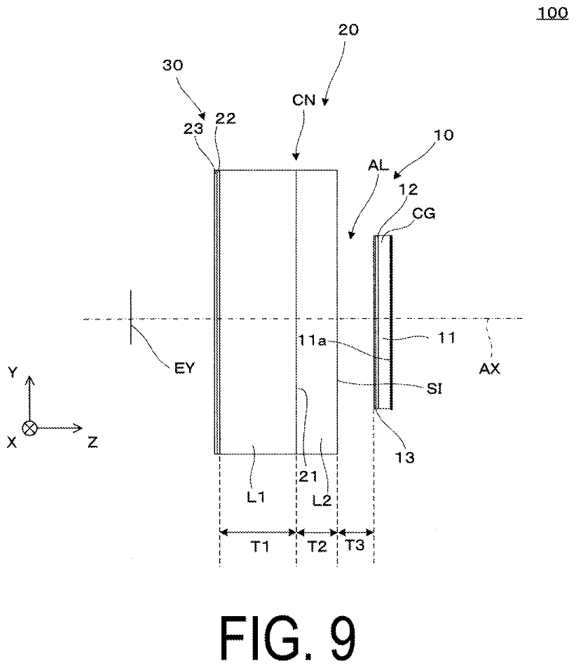

First, FIG. 9 is a side cross-sectional view for conceptually describing a modified example of the virtual image display device according to First Exemplary Embodiment and the like. FIG. 9 is a view corresponding to the virtual image display device 100 illustrated in FIG. 1. In the virtual image display device 100 illustrated in FIG. 1, the thickness T2 of the second lens L2 and the thickness T3 of the air layer AL are T2<T3. In contrast, T2>T3 in a virtual image display device 100 in a modified example illustrated in FIG. 9. Namely, an air layer AL is thinner and a second lens L2 is thicker. In this case, improvement in peripheral resolution performance is expected.

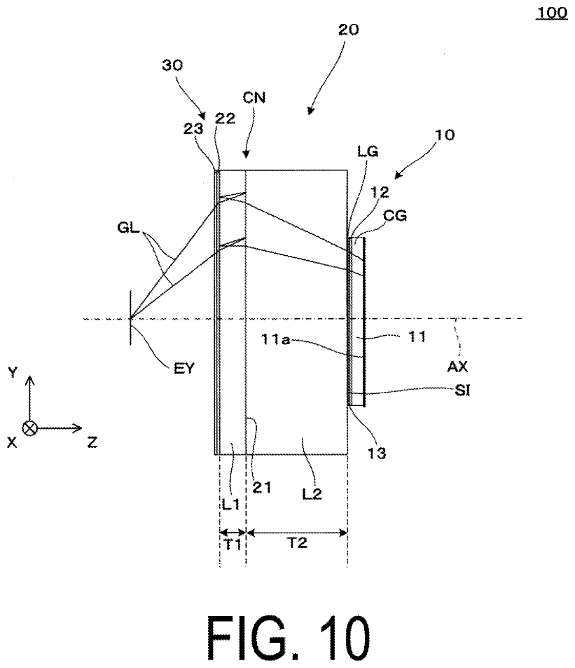

Next, FIG. 10 is a side cross-sectional view for conceptually describing another modified example of the virtual image display device according to First Exemplary Embodiment and the like. FIG. 10 is a view corresponding to the virtual image display device 100 illustrated in FIG. 1. In a virtual image display device 100 in a modified example illustrated in FIG. 10, a light-guiding portion LG is provided instead of an air layer AL between an image display device 10 and an enlargement optical system 20.

Details of the light-guiding portion LG will be described below. The light-guiding portion LG is provided between the image display device 10 and the enlargement optical system 20, and keeps the image display device 10 and the enlargement optical system 20 in close contact with each other to guide the image light GL. In other words, the light-guiding portion LG bonds the image display device 10 and the enlargement optical system 20 together to provide no air space in the light guide. Here, the light-guiding portion LG is an adhesive portion configured to keep in close contact with each other an incident side polarization conversion member 13 located furthest downstream of an optical path of the image display device 10, that is, located closest to the enlargement optical system 20 and a second lens L2 located furthest upstream of an optical path of the enlargement optical system 20, that is, located closest to the image display device 10. The light-guiding portion LG being an adhesive portion includes a light-guiding layer formed by providing and curing a sufficiently high light transmissive adhesive in a layered form. Note that various types of adhesives are applicable as the adhesive used as a material constituting the light-guiding portion LG, but a material having a transmissivity of greater than or equal to 1.3 is used here. Additionally, an adhesive that cures by thermal curing or UV curing is conceivably applied. Namely, the light-guiding portion LG is formed by an adhesive portion obtained by curing an adhesive by heat processing or irradiation with UV light.

As described above, in the virtual image display device 100 in a modified example illustrated in FIG. 10, the light-guiding portion LG is provided in close contact with the image display device 10 and the second lens L2 without an air space, thus, for example, a state according to a total reflection condition in the location is maintained, and at the same time, reliable light guide of the image light GL can be maintained. Note that here, the close contact in the light-guiding portion LG means that, for example, there is no state where at an interface between the image display device 10 and the enlargement optical system 20 and inside the light-guiding portion LG, an unintentional air layer and the like is formed to affect the light guide of the image light GL, and there is no gap to the extent that a state where the image light GL passes through an optical path assumed based on a refractive index and the like inherent in a material of each member configured to guide light can be maintained.

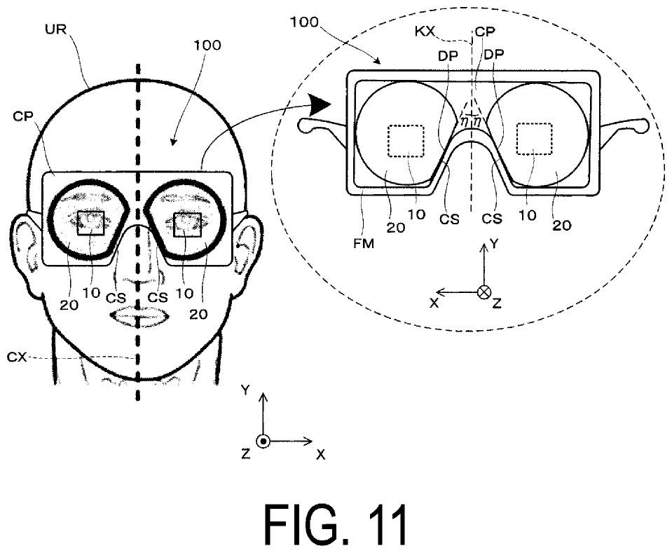

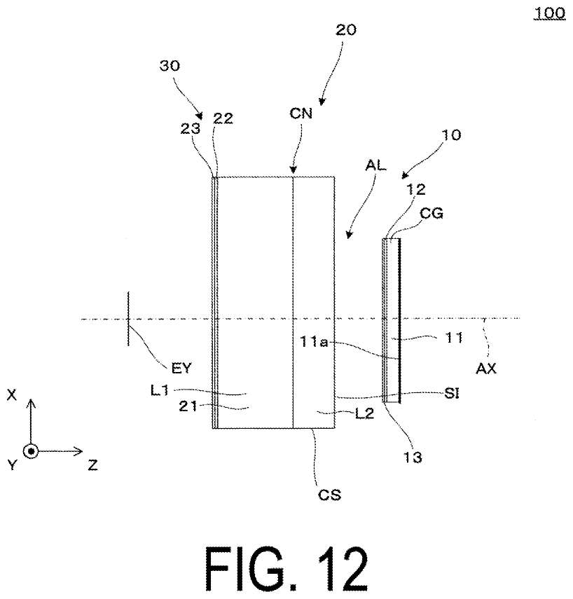

Next, FIG. 11 is a conceptual view of an appearance and a configuration for describing the virtual image display device in a still another modified example according to First Exemplary Embodiment and the like. FIG. 12 is a plane cross-sectional view for conceptually describing a configuration example of the virtual image display device in FIG. 11, that is, a cross section taken along an optical axis AX as viewed from above. Note that FIG. 12 illustrates a configuration example of a left eye side of an image display device 10 and an enlargement optical system 20 each in a right-left pair configuration.

In the virtual image display device 100 in a modified example illustrated in FIG. 11, the enlargement optical system 20 of the image display device 10 and the enlargement optical system 20 that are housed and protected by an outer packaging portion CP has a shape (D shape) obtained by cutting a portion of a circular shape that is a regular lens shape in a front view.

In the exemplary embodiment, a portion of a location corresponding to a region in a nose side of an observer when the device is mounted is removed (cut) slantingly. Here, a lens formed in a shape in which a regular circular shape is partially cut, namely, a lens formed in a shape less symmetric as compared to symmetry of a circular shape is referred to as an asymmetric lens or a cut lens. Additionally, an end face of the lens formed in a portion cut in a cutout shape is referred to as a lens end face. Namely, with reference to FIG. 11 and the like, it can be understood that the enlargement optical system 20 is a cut lens that is an asymmetric lens, and includes a lens end face CS that is flat (linear). That is, as illustrated in a configuration example of the left eye side in FIG. 12, the enlargement optical system 20 in the X direction in which eyes are aligned is not symmetric with respect to an optical axis AX, and includes a short configuration in which a portion of the −X side (nose side) is cut, or an asymmetric configuration.

Further, as partially enlarged and illustrated in FIG. 11, when the virtual image display device 100 is viewed from a reverse side (rear side), in the enlargement optical system 20, the lens end face CS that is slant and flat (linear) is utilized to bring the lens end face CS into contact with a position determining portion DP of a frame FM that is slant and flat (linear) and is an attachment portion disposed in the outer packaging portion CP. Thus, the attachment of the lens can be carried out with high precision and high efficiency as compared with the case of position determination (position adjustment) of a circular lens in a rotatable state, for example. That is, in attachment in the position determining portion DP of the frame FM, the lens end face CS functions as a contact portion processed to be flat.

Additionally, in the virtual image display device 100, lens end faces CS and CS are slanted to dispose in a horizontally symmetric manner with respect to a center axis CX of a face of an observer UR in enlargement optical systems 20 and 20 that are paired right and left. When the above-described configuration is described by using only the configuration of the virtual image display device 100 without referring to the observer UR, it can be stated that the virtual image display device 100 includes a structure that is horizontally symmetric with respect to a center axis KX between the right and left lenses (see the partially enlarged view in FIG. 11) corresponding to the center axis CX, and a pair of the lens end faces CS and CS are slanted to be disposed in a symmetric manner with respect to the center axis KX, that is, the lens end faces CS and CS have slant angles rᵢ of an identical magnitude. Here, the magnitude of the slant angle rᵢ of each lens end face CS with respect to the center axis KX (center axis CX) can take various values within the range from 0° to 90° by an optical design and the like, and is determined to be within an appropriate range while influence on image quality or fitting to a human face and the like is considered. As a specific numeric value, η of approximately 30° or within the range from 20° to 40° is conceivable.

Others

The present disclosure is described above based on the exemplary embodiments. However, the present disclosure is not limited to the above-described exemplary embodiments, and can be embodied in various aspects without departing from the spirit and scope of the present disclosure.

First, in the above description, for example, in First Exemplary Embodiment, the first lens L1 and the second lens L2 are described to be a resin lens in principle. However, for example, a glass lens or a mixture of a glass lens and a resin lens is also applicable depending on various requirements and the like such as a value of a refractive index. Note that when a resin lens is used, for example, it is also conceivable that the resin lens includes any of a resin lens having zero birefringence and a resin lens having low birefringence (that is, a resin lens having orientation birefringence of ±0.01 or less, or having a photoelastic constant 10[10-12/Pa] or less) to make birefringence unlikely to occur.

Additionally, in the above description, in an example of FIG. 10, the light-guiding portion LG is the adhesive portion formed by providing and curing an adhesive in a layered form, but the light-guiding portion LG is not limited to this example. For example, a member having sufficiently high light transparency and having no adhesive property may be provided between the image display device 10 and the second lens L2 and in close contact with the image display device 10 and the second lens L2. For example, the light-guiding portion LG may include grease, oil, and the like. In this case, various methods for providing a structure configured to hold the light-guiding portion LG between the image display device 10 and the second lens L2 are applicable to grease, oil, and the like.

Additionally, it is also conceivable to provide, as the light-guiding portion LG, a structure including an optical flat surface between the image display device 10 and the second lens L2, and it is further conceivable to utilize a transparent tape as long as accuracy in light transmission can be maintained.

Additionally, in the above description, the first lens L1 and the second lens L2 each entirely have a Fresnel shape. However, a configuration in which in a center portion close to the optical axis AX, a regular lens is provided to place emphasis on improvement of a field curvature, and in a peripheral portion from the optical axis AX, a lens having a serrated sectional shape such as a Fresnel structure is provided to place emphasis on correcting a field curvature is also conceivable.

Additionally, various aspects are also conceivable for the manufacturing steps. For example, it is conceivable that concentric Fresnel surfaces are captured to be front surfaces by utilizing the shape of the Fresnel surface FV1 of the first lens L1 and the Fresnel surface FV2 of the second lens L2 that are concentrically engraved, and alignment is performed to cause the Fresnel surfaces to coincide with each other.

Additionally, in the above description, the image display device 10 includes, for example, a light-emitting type element (OLED) such as an organic EL, but, in this case, for example, an element configured to emit circularly polarized image light from the panel unit 11 may be adopted, and the polarizing plate 12 and the incident side polarization conversion member 13 may be omitted. Additionally, it is also conceivable to utilize cholesteric liquid crystals as a circularly polarized selective optical element.

Additionally, as the image display device 10, in addition to HTPS as a transmissive liquid crystal display device, various kinds of image display devices other than the image display devices described above can be utilized. For example, a configuration using a reflective liquid crystal display device can also be employed, or a digital micro-mirror device and the like can also be used in place of the image display element including a liquid crystal display device and the like.

Additionally, occurrence of ghost light or the like may further be suppressed by appropriately providing AR coating in a lens surface of each lens.

Additionally, the techniques of the present disclosure may be employed in a so-called closed-type (not a see-through type) virtual image display device configured to make only image light visually recognized. In addition, the techniques of the present disclosure may also be employed in a device enabling an observer to visually recognize or observe an external world image in a see-through manner and may be applied to a so-called video see-through product including a display device and an image device.

Additionally, the techniques of the present disclosure are applicable to a binocular type hand held display or the like.

Additionally, in the above description, as for a location in which the half mirror 21 including the semi-reflective and semi-transmissive film configured to transmit a portion of image light and reflects another portion is provided, for example, it is also conceivable that a function equivalent to an action by the half mirror 21 is obtained by providing an optical function surface such as a diffraction element, for example, a volume hologram, instead of the half mirror.

Additionally, in the above description, the light emitting surface in the front-of-eye side and the light incident surface on which the image light is incident are the light emitting plane SE and the light incident plane SI, respectively, that is, both are flat surfaces, but it is conceivable that these surfaces are curved surfaces.

Additionally, in the above description, the configuration in which the half mirror 21 is provided in the first lens L1 side is described, but a configuration in which the half mirror 21 is provided in the second lens L2 side can also be achieved.

Additionally, a tip of a location having an angled shape in the serrated surface may be rounded to the extent that does not affect the optical function.

In addition to the description above, for example, an entrance pupil may be shifted and disposed downward from a center position of the Fresnel lens by an angle of approximately 10 degrees. From a perspective of ergonomics, a natural line-of-sight angle is known to be approximately 10° downward, and also in an HMD, more natural and comforting video viewing can be provided by shifting the center of an image, that is, an entrance pupil to 10° downward.

As described above, the virtual image display device in an aspect of the present disclosure includes an image element configured to display an image, a first optical unit disposed at a position where image light is extracted, a second optical unit disposed at the image element side with respect to the first optical unit, a half mirror provided on a serrated surface formed at a bonding portion between the first optical unit and the second optical unit, and a transmission/reflection selection member that is provided at a light emitting side of the first optical unit and that is configured to selectively transmit or reflect light depending on a polarization state of the light.

In the above-described virtual image display device, the first optical unit and the second optical unit are bonded, and the half mirror is provided in the bonding portion of the first optical unit and the second optical unit. Thus, miniaturization or thinning is realized, and at the same time, power is provided to perform image formation with a wide angle of view. At this time, in particular, the half mirror is provided on the serrated surface formed at the bonding portion between the first optical unit and the second optical unit. Thus, necessary power is provided, and at the same time, further thinning and miniaturization can be achieved, and occurrence of a field curvature can also be suppressed.

In a specific aspect of the present disclosure, at least one of the first optical unit and the second optical unit includes, as an optical surface in the bonding portion side, a surface having a shape corresponding to a shape of the serrated surface. In this case, a half mirror having a desired shape can be provided in the surface of the first optical unit or the second optical unit.

In another aspect of the present disclosure, the first optical unit includes, as an optical surface in the bonding portion side, a surface having a shape corresponding to a shape of the serrated surface, and the second optical unit includes a flat surface in the bonding portion side. In this case, the half mirror having a desired shape is provided in the first optical unit, and at the same time, a shape of the second optical unit can be simplified.

In still another aspect of the present disclosure, at least one of the first optical unit and the second optical unit is a Fresnel lens including the serrated surface. In this case, occurrence of a field curvature can be suppressed by utilizing characteristics of the Fresnel lens.

In still another aspect of the present disclosure, the bonding portion includes an adhesive film that is formed by curing an adhesive and that has the same refractive index as a refractive index of a material for an optical unit directly bonded of the first optical unit and the second optical unit. In this case, a material having the same refractive index is used, thus the adhesive film formed by curing the adhesive can be integrated with the optical unit directly bonded as an optical function.

In still another aspect of the present disclosure, the serrated surface has a difference in a height from a center side of the image light toward a peripheral side. In this case, for example, an adhesive used during bonding can be spread reliably.

In still another aspect of the present disclosure, a tapered surface is provided in a surface including the serrated surface, as a side surface portion that forms a step. In this case, the side surface portion getting stuck during bonding can be avoided.

In still another aspect of the present disclosure, a size of an image display area of the image element is smaller than a size of an optical surface of the second optical unit. In this case, miniaturization of the image element and consequently miniaturization of the whole device can be achieved.

In still another aspect of the present disclosure, the second optical unit is thinner than an air gap thickness from the image element to the second optical unit in an optical axis direction. In this case, weight reduction of the virtual image display device and a configuration that is strong to a manufacturing tolerance can be achieved.

In still another aspect of the present disclosure, the first optical unit and the second optical unit are asymmetric lenses including lens end faces formed by cutting a portion of a member. In this case, fitting to a human face is considered, and at the same time, miniaturization and a reduction in a weight of the lens and consequently miniaturization and a reduction in a weight of the device can be achieved.

In still another aspect of the present disclosure, each of the lens end faces includes a contact portion processed to be flat. In this case, a flat contact portion can be utilized to determine a position of an asymmetric lens with high precision and high efficiency. Further, a flat portion (linear portion) is disposed in the nose side, thus in a case of a configuration including a pair of lenses, a distance between positions of right and left lenses can be further shortened.

In still another aspect of the present disclosure, the asymmetric lenses are configured to be paired right and left, and the lens end faces are disposed to be symmetrically slanted with respect to a center axis between right and left lenses. In this case, a space for a nose of an observer can be secured with good symmetry.

An enlargement optical system in an aspect of the present disclosure includes a Fresnel lens including a serrated surface, a half mirror provided on the serrated surface of the Fresnel lens, a counter member configured to sandwich the half mirror with the Fresnel lens at a bonding portion between the counter member and the Fresnel lens, and a transmission/reflection selection member configured to selectively transmit or reflect light that passed through the half mirror, depending on a polarization state of the light.

In the enlargement optical system described above, the half mirror is provided at the bonding portion between the Fresnel lens and the counter member. Thus, miniaturization or thinning is realized, and at the same time, power is provided. At this time, in particular, the half mirror can be provided in the serrated surface. As a result, necessary power is provided, and at the same time, further thinning and miniaturization can be achieved, and occurrence of a field curvature can also be suppressed.

What is claimed is:

1. A virtual image display device comprising:
an image element configured to display an image;
a first optical unit disposed at a position where image light is extracted;
a second optical unit disposed at the image element side with respect to the first optical unit;
a half mirror provided on a serrated surface formed at a bonding portion between the first optical unit and the second optical unit; and
a transmission/reflection selection member that is provided at a light emitting side of the first optical unit and that is configured to selectively transmit or reflect light depending on a polarization state of the light.

2. The virtual image display device according to claim 1, wherein
at least one of the first optical unit and the second optical unit includes, as an optical surface at the bonding portion side, a surface having a shape corresponding to a shape of the serrated surface.

3. The virtual image display device according to claim 2, wherein
the first optical unit includes, as an optical surface at the bonding portion side, a surface having a shape corresponding to a shape of the serrated surface, and
the second optical unit includes a flat surface at the bonding portion side.

4. The virtual image display device according to claim 1, wherein
at least one of the first optical unit and the second optical unit is a Fresnel lens including the serrated surface.

5. The virtual image display device according to claim 1, wherein
the bonding portion includes an adhesive film that is formed by curing an adhesive and that has the same refractive index as a refractive index of a material of an optical unit, of the first optical unit and the second optical unit, that is directly bonded.

6. The virtual image display device according to claim 1, wherein
the serrated surface has a difference in height from a center side of the image light toward a peripheral side.

7. The virtual image display device according to claim 1, wherein
in a surface including the serrated surface, a tapered surface is provided as a side surface portion that forms a step.

8. The virtual image display device according to claim 1, wherein
a size of an image display area of the image element is smaller than a size of an optical surface of the second optical unit.

9. The virtual image display device according to claim 1, wherein
the second optical unit is thinner, in an optical axis direction, than an air gap thickness from the image element to the second optical unit.

10. The virtual image display device according to claim 1, wherein
the first optical unit and the second optical unit are asymmetric lenses including lens end faces formed by cutting a portion of a member.

11. The virtual image display device according to claim 10, wherein
each of the lens end faces includes a contact portion processed to be flat.

12. The virtual image display device according to claim 10, wherein
the asymmetric lenses are configured to be paired right and left, and the lens end faces are disposed to be symmetrically slanted with respect to a center axis between right and left lenses.

13. An enlargement optical system comprising:
a Fresnel lens including a serrated surface;
a half mirror provided on the serrated surface of the Fresnel lens;
a counter member configured to sandwich, with the Fresnel lens, the half mirror at a bonding portion between the counter member and the Fresnel lens; and
a transmission/reflection selection member configured to selectively transmit or reflect light that passed through the half mirror, depending on a polarization state of the light.
